(19) United States
(12) Patent Application Publication
(10) Pub. No.: US 2025/0336118 A1
(43) Pub. Date: Oct. 30, 2025

(54) DISPLAY METHOD AND DISPLAY APPARATUS

(71) Applicant: Gigaphoton Inc., Tochigi (JP)

(72) Inventors: Jacob Peter STROCK, Beaverton, OR (US); Levi JORDAN, Beaverton, OR (US); Yuji MINEGISHI, Oyama-shi (JP)

(73) Assignee: Gigaphoton Inc., Tochigi (JP)

(21) Appl. No.: 19/263,473

(22) Filed: Jul. 8, 2025

Related U.S. Application Data
(63) Continuation of application No. PCT/JP2023/045671, filed on Dec. 20, 2023.
(60) Provisional application No. 63/484,956, filed on Feb. 14, 2023.

(51) Int. Cl. G06T 11/20; G03F 7/00

(52) U.S. Cl. CPC G06T 11/206; G03F 7/70025; G03F 7/70508; G06T 2200/24

(57) ABSTRACT

A display method is for displaying estimation result data of a feature of a laser device after an estimation start timing, the estimation result data being obtained using a trained model and actual data of the laser device up to the estimation start timing. The display method includes storing the actual data and the estimation result data, generating a display screen in which temporal transition of the actual data and temporal transition of the estimation result data are connected and displayed, and displaying the display screen.

### CROSS-REFERENCE TO RELATED APPLICATIONS

The present application is a continuation application of International Application No. PCT/JP2023/045671, filed on Dec. 20, 2023, with the priority of U.S. Patent Application No. 63/484,956, filed on Feb. 14, 2023, the entire contents of which are hereby incorporated by reference.

### BACKGROUND

### 1. Technical Field

The present disclosure relates to a display method and a display apparatus.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 μm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be line-narrowed to the extent that the chromatic aberration can be ignored. For this purpose, there is a case in which a line narrowing module (LNM) including a line narrowing element (etalon, grating, and the like) is provided in a laser resonator of the gas laser device to line-narrow a spectral line width. In the following, a gas laser device with a narrowed spectral line width is referred to as a line narrowing gas laser device.

### LIST OF DOCUMENTS

### Patent Documents

Patent Document 1: US Patent Application Publication No. 2021/0333788
Patent Document 2: US Patent Application Publication No. 2021/0117931
Patent Document 3: Japanese Patent Application Publication No. 2021-177223

### SUMMARY

A display method, according to an aspect of the present disclosure, is for displaying estimation result data of a feature of a laser device after an estimation start timing, the estimation result data being obtained using a trained model and actual data of the laser device up to the estimation start timing. Here, the display method includes storing the actual data and the estimation result data, generating a display screen in which temporal transition of the actual data and temporal transition of the estimation result data are connected and displayed, and displaying the display screen.

A display apparatus, according to another aspect of the present disclosure, is for displaying estimation result data of a feature of a laser device after an estimation start timing, the estimation result data being obtained using a trained model and actual data of the laser device up to the estimation start timing. Here, the display apparatus includes a storage device configured to store the actual data and the estimation result data, a processing device configured to generate a display screen in which temporal transition of the actual data and temporal transition of the estimation result data are connected and displayed, and a monitor configured to display the display screen.

### BRIEF DESCRIPTION OF THE DRAWINGS

Embodiments of 41 the present disclosure will be described below merely as examples with reference to the accompanying drawings.

FIG. 1 is a view showing the configuration of an exemplary laser device for an exposure apparatus.

FIG. 2 is a diagram showing the configuration of an exemplary light source management system.

FIG. 3 is a table showing specific examples of a component replacement scenario.

FIG. 4 is a table showing specific examples of a laser setting scenario.

FIG. 5 is a diagram showing estimation result data with respect to a maintenance scenario using a trained model or the like.

FIG. 6 is a diagram showing processing flow of a display method of a display apparatus according to a first embodiment.

FIG. 7 is a diagram showing a display screen according to the first embodiment.

FIG. 8 is a diagram showing the display screen according to a second embodiment.

FIG. 9 is a diagram showing another display screen according to the second embodiment.

### DESCRIPTION OF EMBODIMENTS

### <Contents>

1. Description of terms
2. Device according to comparative example
   2.1 Laser device
      2.1.1 Configuration
      2.1.2 Operation
   2.2 Light source management system
      2.2.1 Configuration
      2.2.2 Operation
3. Problem
4. First Embodiment
   4.1 Configuration
   4.2 Operation
   4.3 Effect
5. Second Embodiment
   5.1 Configuration
   5.2 Operation
   5.3 Effect
6. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Description of Terms

Terms used in the present specification are defined as follows.

A “feature” is a quantifiable feature of a laser device. Examples of the feature include a pulse energy of pulse laser light output from the laser device, a center wavelength, a spectral line width, a gas pressure in a chamber, an application voltage between electrodes, and a number of used pulses of respective components.

### 2. Device According to Comparative Example

2.1 Laser device

### 2.1.1 Configuration

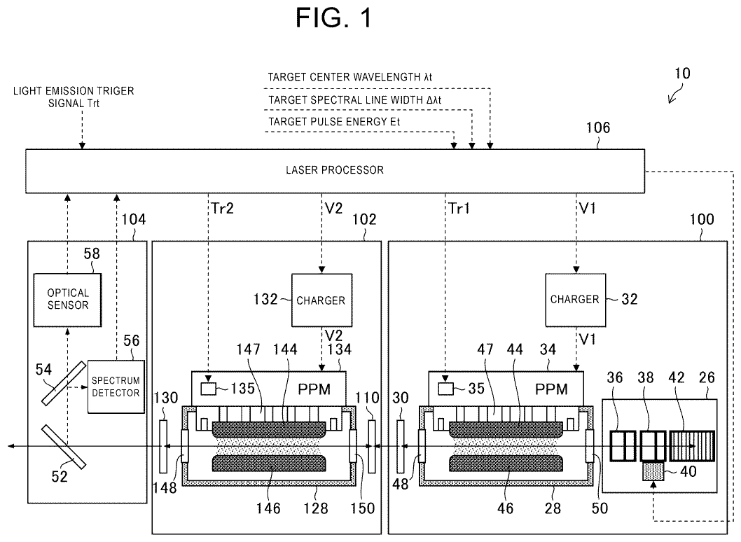

FIG. 1 shows the configuration of a laser device 10 for an exposure apparatus according to a comparative example. The comparative example of the present disclosure is an example recognized by the applicant as known only by the applicant, and is not a publicly known example admitted by the applicant.

The laser device 10 is, for example, an excimer laser device, and includes an oscillator (OSC) 100, an amplifier (AMP) 102, a monitor module 104, and a laser processor 106.

The OSC 100 includes a line narrowing module (LNM) 26, a chamber 28, an output coupler (OC) 30, a charger 32, and a pulse power module (PPM) 34. The PPM 34 includes a switch 35.

The LNM 26 includes a first prism 36, a second prism 38, a rotation stage 40 that rotates the second prism 38, and a grating 42. The LNM 26 changes an incident angle on the grating 42 by rotating the second prism 38 so that a center wavelength of pulse laser light is controlled. The rotation stage 40 may be a rotation stage including a piezoelectric element.

The chamber 28 includes a pair of electrodes 44, 46, an insulating member 47, and two windows 48, 50 through which laser light is transmitted. An excimer laser gas is introduced into the chamber 28. The excimer laser gas includes, for example, a rare gas (an Ar gas or a Kr gas), a halogen gas (an F₂ gas), and a buffer gas (an Ne gas). The PPM 34 is connected to the electrode 44 via a feedthrough in the insulating member 47.

The OC 30 is a partial reflection mirror that reflects a part of the pulse laser light and transmits the other part.

The LNM 26 and the OC 30 may configure an optical resonator, and the chamber 28 may be arranged on the optical path of the optical resonator.

The AMP 102 includes a rear mirror (RM) 110, a chamber 128, an OC 230, a charger 132, and a PPM 234. The PPM 134 includes a switch 135. The configurations of the chamber 128, the charger 132, and the PPM 134 are similar to those of the corresponding elements of the OSC 100.

The RM 110 is a partial reflection mirror that reflects a part of the pulse laser light and transmits the other part. The reflectance of the RM 110 may be between 80% and 90%.

The chamber 128 includes a pair of electrodes 144, 146, an insulating member 147, and two windows 148, 150 through which laser light is transmitted. An excimer laser gas is introduced into the chamber 128.

The OC 130 is a partial reflection mirror that reflects a part of the pulse laser light and transmits the other part. The reflectance of the OC 130 may be between 10% and 30%.

The LNM 110 and the OC 130 may configure an optical resonator, and the chamber 128 may be arranged on the optical path of the optical resonator. The optical resonator may be a Fabry-Perot optical resonator.

The monitor module 104 includes a first beam splitter 52, a second beam splitter 54, a spectrum detector 56 that measures a wavelength and a spectral line width of the pulse laser light, and an optical sensor 58 that detects a pulse energy of the pulse laser light. The spectrum detector 56 may be an etalon spectrometer. The optical sensor 58 may be a photodiode.

### 2.1.2 Operation

The laser processor 106 receives a target center wavelength λt, a target spectral line width Δλt, and a target pulse energy Et from an exposure apparatus (not shown). The laser processor 106 sets a charge voltage V1 of the charger 32 and a charge voltage V2 of the charger 132 so that the pulse laser light having the target pulse energy Et can be obtained.

A charging capacitor (not shown) in the PPM 34 is charged with the charge voltage V1. A charging capacitor (not shown) in the PPM 134 is charged with the charge voltage V2.

Upon receiving a light emission trigger signal Trt from the exposure apparatus, the laser processor 106 transmits the light emission trigger signal Tr1 to the switch 35 in the PPM 34. When the switch 35 is operated, charges charged in the charging capacitor are converted into high voltage pulses in the PPM 34 in accordance with the charge voltage V1 and applied between the electrodes 44, 46 in the chamber 28.

As a result, discharge occurs between the electrodes 44, 46, and the excimer laser gas in the chamber 28 is excited. Then, the seed light line-narrowed by the optical resonator configured of the OC 30 and the LNM 26 to an ultraviolet wavelength of 150 to 380 nm is output from the OSC 100. The wavelength of the seed light may be an oscillation wavelength of the ArF excimer laser or an oscillation wavelength of the KrF excimer laser.

Upon receiving the light emission trigger signal Trt from the exposure apparatus, the laser processor 106 transmits a light emission trigger signal Tr2 to the switch 135 of the PPM 134 so that discharge occurs between the electrodes 144, 146 when the seed light output from the OSC 100 enters the discharge space in the chamber 128 of the AMP 102.

When the switch 135 is operated, charges charged in the charging capacitor (not shown) in the PPM 134 are converted into high voltage pulses in the PPM 134 in accordance with the charge voltage V2 and applied between the electrodes 144, 146 in the chamber 128.

As a result, discharge occurs between the electrodes 144, 146, and the excimer laser gas in the chamber 128 is excited. At this timing, the seed light output from the OSC 100 is transmitted through the RM 110 and enters the discharge space in the chamber 128. The entering seed light is amplified by the optical resonator configured of the OC 130 and the RM 110, and is output from the AMP 102.

The pulse laser light output from the AMP 102 enters the monitor module 104.

A part of the pulse laser light entering the monitor module 104 is reflected by the first beam splitter 52, and a part of the reflected pulse laser light is further reflected by the second beam splitter 54 to enter the spectrum detector 56. Further, the pulse laser light transmitted through the second beam splitter 54 enters the optical sensor 58.

The spectrum detector measures the center wavelength and the spectral line width of the pulse laser light. The optical sensor 58 measures the pulse energy of the pulse laser light.

The laser processor 106 may control the rotation stage 40 in the LNM 26 so that the center wavelength measured by the spectrum detector 56 becomes the target center wavelength λt.

The laser processor 106 may control the charge voltage V2 output from the charger 132 so that the pulse energy measured by the optical sensor 58 becomes the target pulse energy Et.

### 2.2 Light Source Management System

### 2.2.1 Configuration

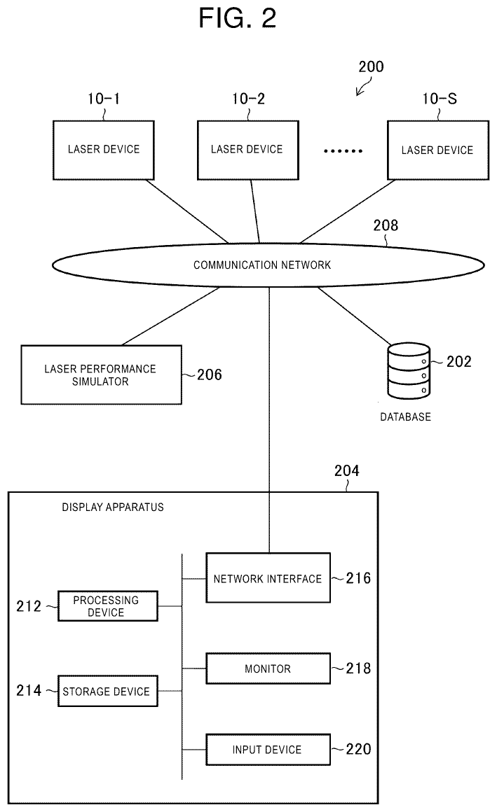

FIG. 2 shows the configuration of a light source management system 200 according to the comparative example. The light source management system 200 includes a plurality of laser devices 10-1, 10-2, . . . , 10-S that output pulse laser light, a database 202, a display apparatus 204, and a laser performance simulator 206.

The plurality of laser devices 10-1, 10-2, . . . , 10-S may be all laser devices in a semiconductor factory. The laser device may be an excimer laser device. Each of the plurality of laser devices 10-1, 10-2, . . . , 10-S has a unique laser identification number.

The database 202 may be arranged in the semiconductor factory or in the laser device.

The display apparatus 204 includes a processing device 212, a storage device 214, a network interface 216, a monitor 218, and an input device 220. Each of the components may be provided in plural.

The processing device 212 may be a central processing (CPU), a graphics processing unit (GPU), or a unit combination thereof.

The storage device 214 may be a volatile memory, a non-volatile memory, a hard disk drive (HDD), a solid state drive (SSD), or a universal serial bus (USB) memory.

The network interface 216 is an interface for connecting to the communication network 208 by wired or wireless communication or a combination thereof.

The monitor 218 may be a liquid crystal display (LCD) or an organic electroluminescent display.

The input device 220 may be a keyboard, a mouse, or an audio input device.

The laser performance simulator 206 includes a processing device (not shown), a storage device (not shown), a network interface (not shown), a monitor (not shown), and an input device (not shown). Further, each of the components may be provided in plural.

The plurality of laser devices 10-1, 10-2, . . . , 10-S, the display apparatus 204, and the laser performance simulator 206 are connected to each other via the communication network 208.

The communication network 208 is a communication network capable of transmitting information by wired or wireless communication or a combination thereof. The communication network 208 may be a wide area network or a local area network.

### 2.2.2 Operation

Actual data from the plurality of laser devices 10-1, 10-2, . . . , 10-S is continuously stored in the database 202 in association with a total number of oscillation pulses of each of the laser devices and the date and time. The actual data includes, for example, the gas pressure in the chamber 28, the charge voltage V1, the number of used pulses of the chamber 28, and the number of used pulses of the LNM 26.

The data in the database 202 may be accessed from the laser performance simulator 206 and the display apparatus 204 via the communication network 208.

The storage device of the laser performance simulator 206 stores a trained model for quantitative estimation of temporal transition (performance) of a feature of the laser device 10 in the future including any one of the laser devices 10-1, 10-2, 10-S, for example. The model is, for example, a recurrent neural network model. The temporal transition of the feature is a change in the feature of the laser device 10 in accordance with the date and time, or a change in the feature of the laser device 10 in accordance with the total number of oscillation pulses of the laser device 10.

The trained model estimates the performance of a laser device with respect to a maintenance scenario using the actual data of the laser device 10 stored in the database 202. The maintenance scenario includes at least one of a component replacement scenario and a laser setting scenario.

When a field service engineer determines maintenance such as component replacement or changing a setting parameter of the laser setting, the field service engineer estimates the performance of the laser device 10 in the future with respect to the maintenance scenario using the trained model or the like.

Then, the field service engineer determines to perform maintenance based on the estimation result data.

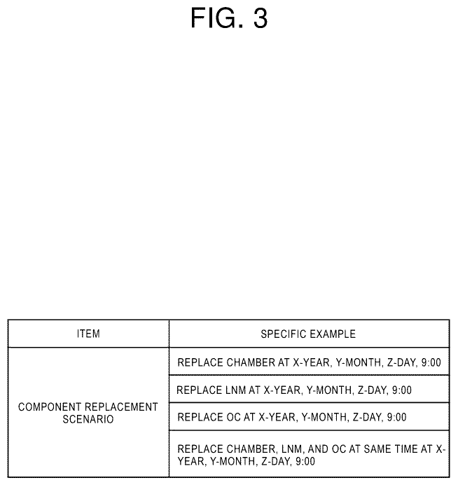

The component replacement scenario includes data of the replacement component that is a component to be replaced and a component replacement timing at which the replacement component is to be replaced. FIG. 3 shows specific examples of the component replacement scenario. Specific examples of the component replacement scenario are four types: a case in which the chamber 28 is replaced at X-year, Y-month, Z-day, 9:00; a case in which the LNM 26 is replaced at X-year, Y-month, Z-day, 9:00; a case in which the OC 30 is replaced at X-year, Y-month, Z-day, 9:00; and a case in which the chamber 28, the LNM 26, and the OC 30 are replaced at X-year, Y-month, Z-day, 9:00.

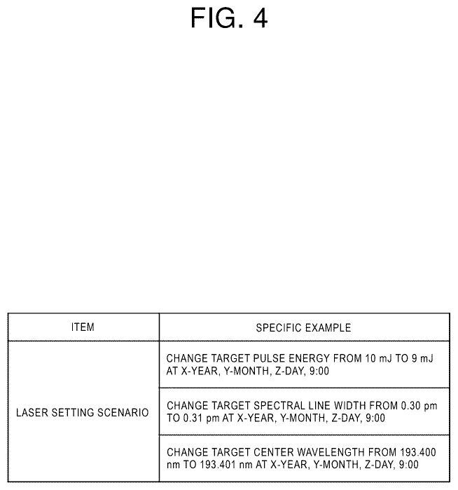

The laser setting scenario includes data of the value of the setting parameter of the laser setting of the laser device 10 to be changed and the parameter setting timing at which the laser setting is to be changed. FIG. 4 shows specific examples of the laser setting scenario. Specific examples of the laser setting scenario are three types: a case in which the target pulse energy Et is changed from 10 mJ to 9 mJ at X-year, Y-month, Z-day, 9:00; a case in which the target spectral line width Δλt is changed from 0.30 pm to 0.31 pm at X-year, Y-month, Z-day, 9:00; and a case in which the target center wavelength λt is changed from 193.400 nm to 193.401 nm at X-year, Y-month, Z-day, 9:00.

Here, the replacement timing included in the component replacement scenario and the change timing included in the laser setting scenario may be represented by the total number of oscillation pulses of the laser device 10 instead of the date and time.

### 3. Problem

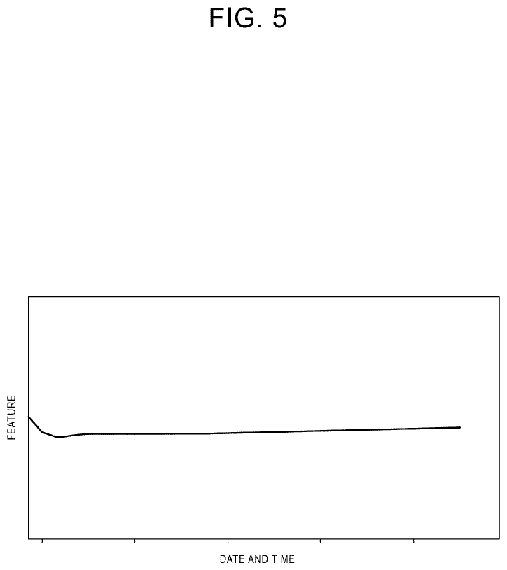

FIG. 5 shows the estimation result data with respect to the maintenance scenario using the trained model or the like. The estimation result data shown in FIG. 5 is a graph in which the horizontal axis represents the date and time and the vertical axis represents the value of the feature, and shows temporal transition which is a temporal change of the feature from the start of estimation.

When such estimation result data is displayed on the monitor 218, it is difficult to understand the effect of the maintenance scenario only by displaying the temporal transition of the estimation result data.

The present disclosure provides a display method and a display apparatus capable of reducing the difficulty of understanding.

### 4. First Embodiment

### 4.1 Configuration

The apparatus configuration of the EUV light generation system according to a first embodiment is similar to that of the comparative example.

### 4.2 Operation

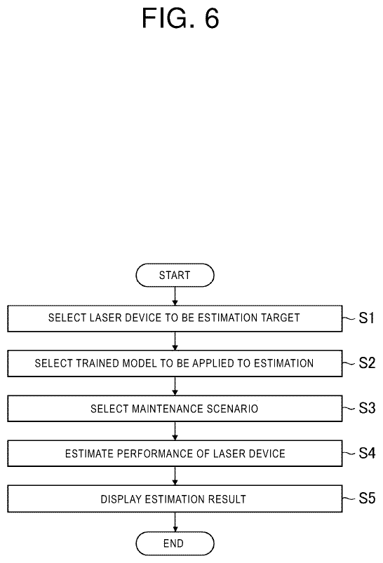

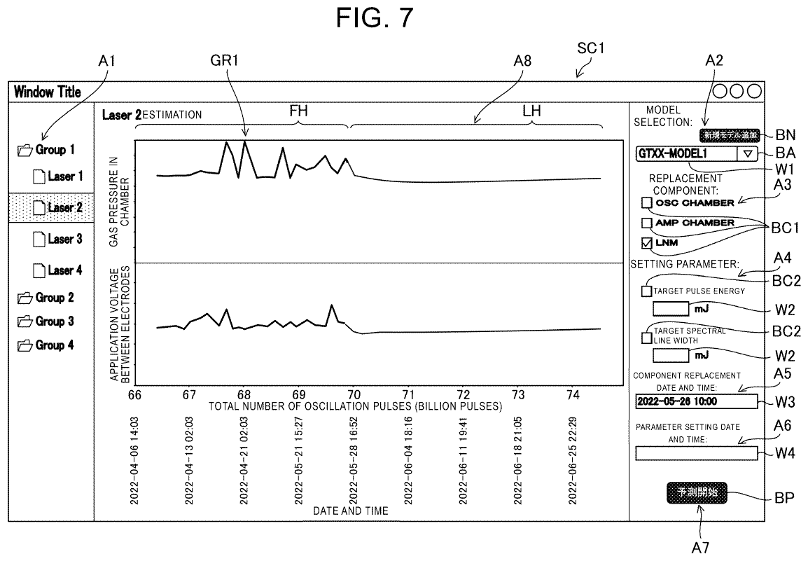

FIG. 6 shows processing flow of a display method of the display apparatus 204 according to the first embodiment. FIG. 7 shows a display screen according to the first embodiment. The display screen is generated by the processing device 212 and is displayed on the monitor 218. A display screen SC1 shown in FIG. 7 includes a laser device selection section A1, a model selection section A2, a replacement component selection section A3, a setting parameter selection section A4, a component replacement date and time input section A5, a parameter setting date and time input section A6, an estimation start section A7, and an estimation result display section A8.

First, in step S1, a user selects the laser device 10I to be an estimation target. The laser device 10I may be a laser device of any of the plurality of laser devices 10-1, 10-2, . . . , 10-S.

The selection of the laser device 10I is performed at the laser device selection section A1. The laser device selection section A1 is arranged at the left end of the display screen SC1. The laser device selection section A1 includes selectable laser devices. The selectable laser devices may be grouped by type. For example, grouping may be performed in accordance with the wavelength of the pulse laser light output from the laser device or the system configuration of the laser device.

In the example shown in FIG. 7, the laser device selection section A1 is grouped into four groups: “Group1”, “Group2”, “Group3”, and “Group4”. The laser devices included in each group can be displayed by operating a group name. In the example shown in FIG. 7, “Group1” is operated, so that four laser devices of “Laser1”, “Laser2”, “Laser3”, and “Laser4” included in “Group1” are displayed to be selectable. A region of the laser device selected as the laser device 10I to be the estimation target is inverted. In the example shown in FIG. 7, the region of “Laser2” is inverted indicating a state that “Laser2” is selected.

Next, in step S2, the user selects the trained model to be applied to the estimation. Selection of the trained model is performed at the model selection section A2. The model selection section A2 is arranged at the upper right end of the display screen SC1. The model selection section A2 includes a model display field W1, an arrow button BA, and a new model addition button BN.

In the model display field W1, the trained model selected by the user is displayed. The arrow button BA is a button for changing the trained model to be displayed in the model display field W1. When the arrow button BA is operated for selection, a drop-down list (not shown) is displayed at the model selection section A2. In the drop-down list, selectable candidates of the trained model are displayed in a juxtaposed manner. The selectable candidates of the trained model are trained models associated with the laser device 10I selected at the laser device selection section A1. When the user selects a desired trained model from among the trained models displayed in the drop-down list, the selected trained model is displayed in the model display field W1, and the drop-down list is hidden.

If a desired trained model does not exist in the drop-down list, the user can add a new trained model to the drop-down list by operating the new model addition button BN.

Here, the feature to be estimated differs depending on the trained model. Therefore, the user selects the trained model taking into account the feature of the laser device 10I desired to be estimated. In the example shown in FIG. 7, “GIXX-MODEL1” is displayed in the model display field W1, and the trained model of “GTXX-MODEL1” is selected.

When the trained model is selected, the processing device 212 reads the trained model selected from the trained models stored in the laser performance simulator 206 via the network interface 216, and stores the selected trained model in the storage device 214. Further, the processing device 212 reads the actual data of the laser device 10I from the database 202 via the network interface 216, and stores the actual data in the storage device 214. The actual data includes data of the features. The actual data may be associated with the total number of oscillation pulses of the laser device 10I and the date and time.

Subsequently, in step S3, the user selects the maintenance scenario. Setting of the replacement component scenario is performed at the replacement component selection section A3 and the component replacement date and time input section A5. Further, setting of the laser setting scenario is performed at the setting parameter selection section A4 and the parameter setting date and time input section A6. The replacement component selection section A3, the setting parameter selection section A4, the component replacement date and time input section A5, and the parameter setting date and time input section A6 are arranged in this order from the top at the right end of the display screen SC1 and below the model selection section A2.

At the replacement component selection section A3, selectable candidates of the replacement component are displayed. The candidates of the replacement component are components associated with the trained model selected at the model selection section A2. In the example shown in FIG. 7, “OSC CHAMBER”, “AMP CHAMBER”, and “LNM” are the selectable components. Here, “OSC CHAMBER” represents the chamber 28, “AMP CHAMBER” represents the chamber 128, and “LNM” represents the LNM 26.

The selectable components are each provided with a checkbox BC1. The user can select a desired component by operating the checkbox BC1 of the desired component and putting a check mark in the checkbox BC1. In the example shown in FIG. 7, “LNM” is selected with a check mark in the checkbox BC1 of “LNM”.

The component replacement date and time input section A5 includes a date and time input field W3. The date and time input field W3 is a text box for the user to input the component replacement date and time. In the example shown in FIG. 7, “2022 May 26 10:00” is input, and 10:00 on May 26, 2022 is designated as the component replacement date and time.

At the setting parameter selection section A4, selectable candidates of the setting parameter of the laser setting are displayed. Candidates of the setting parameter of the laser setting are setting parameters associated with the trained model selected at the model selection section A2. In the example shown in FIG. 7, “target pulse energy” and “target spectral line width” are selectable setting parameters. The selectable setting parameters are each provided with a checkbox BC2. The user can select a desired setting parameter by operating the checkbox BC2 of the desired setting parameter and putting a check mark in the checkbox BC2. In the example shown in FIG. 7, the setting parameter is not selected.

Further, the setting parameter selection section A4 is provided with a numerical value input field W2 for each setting parameter. The user can input a desired value in the numerical value input field W2 of the setting parameter having the checkbox BC2 in which a check mark has been put. In the example shown in FIG. 7, since the setting parameter is not selected, no value is input to the numerical value input field W2.

The parameter setting date and time input section A6 includes a date and time input field W4. The date and time input field W4 is a text box for the user to input the parameter setting date and time. The component replacement date and time input to the date and time input field W3 and the parameter setting date and time input to the date and time input field W4 may be the date and time or the total number of oscillation pulses of the laser device 10I.

The component replacement date and time and the parameter setting date and time can be collectively designated, but can also be designated for each of the replacement components and each of the setting parameters. In this case, an input screen of the date and time similar to the component replacement date and time input section A5 may be displayed in the vicinity of the replacement component selection section A3, or an input screen of the date and time similar to the parameter setting date and time input section A6 may be displayed in the vicinity of the setting parameter selection section A4.

When the selection in steps S1 to S3 is completed, in step S4, the processing device 212 estimates the performance of the feature of the laser device 10I using the trained model selected in step S2 and the actual data of the laser device 10I up to the start of estimation stored in step S2. In other words, the start of estimation is the last time at which the actual data of the laser device 10I exists. Further, the processing device 212 stores the actual data and the estimation result data after the start of estimation in the storage device 214.

The estimation start section A7 is arranged at the right end of the display screen SC1 and below the parameter setting date and time input section A6. The estimation start section A7 includes an estimation start button BP. The estimation start button BP is a button for starting estimation of the performance of the laser device 10I. When the user operates the estimation start button BP, the processing device 212 starts estimation of the performance of the laser device 10I. Here, the start of estimation is 10:00 on May 26, 2022, and the gas pressure in the chamber 28 of the OSC 100 and the application voltage between the electrodes 44, 46 when the LNM 26 is replaced at 10:00 on May 26, 2022, which is the component replacement date and time, are estimated.

Finally, in step S5, the processing device 212 causes the monitor 218 to display the estimation result data of step S4. The processing device 212 generates a display screen in which the temporal transition of the actual data up to the start of estimation and the temporal transition of the estimation result data after the start of estimation are connected and displayed, and displays the generated display screen.

Here, connecting displaying the temporal and transition of the actual data and the temporal transition of the estimation result data is not limited to displaying as connecting, by a line, a last plot point of the actual data and a first plot point of the estimation result data, and for example, the temporal transition of the actual data and the temporal transition of the estimation result data may be arranged and displayed on the same time axis.

The estimation result data is displayed at the estimation result display section A8. The estimation result display section A8 is arranged at a center part of the display screen SC1. In the example shown in FIG. 7, a graph GR1 obtained by connecting the temporal transition of the actual data of the feature up to the start of estimation and the temporal transition of the estimation result data of the feature after the start of estimation is displayed.

The graph GR1 in a region FH indicates the temporal transition of the actual data up to the start of estimation. Further, the graph GR1 in a region LH indicates the temporal transition of the estimation result data after the start of estimation. Here, the temporal transition is the transition of data in accordance with the elapsed time or the transition of data in accordance with the total number of oscillation pulses of the laser device 10I.

The X axis which is the horizontal axis of the graph GR1 may be represented by the total number of oscillation pulses of the laser device 10I, the date and time, or both thereof. In the example shown in FIG. 7, both of the total number of oscillation pulses and the date are shown together on the X axis.

Here, since there are a plurality of features to be estimated, the processing device 212 generates the display screen SC1 in which displaying is separated into the upper and lower stages for the respective features. In the example of FIG. 7, the gas pressure in the chamber 28 is displayed on the upper stage of the graph GR1, and the application voltage between the electrodes 44, 46 is displayed on the lower stage of the graph GR1, with the vertical axis being divided into upper and lower parts. In this case, the X axis may be a common axis.

### 4.3 Effect

By connecting and displaying the temporal transition of the actual data up to the start of estimation and the temporal transition of the estimation result data after the start of estimation, the change in the performance of the laser device 10I before and after the maintenance scenario can be grasped, and difficulty of understanding the effect of the maintenance scenario can be reduced.

### 5. Second Embodiment

### 5.1 Configuration

The apparatus configuration of the light source management system according to a second embodiment is similar to that of the first embodiment.

### 5.2 Operation

Since operation of the display apparatus 204 according to the second embodiment is substantially similar to that of the first embodiment, difference from the first embodiment will be mainly described.

The second embodiment discloses a display method of the estimation result data when there are a plurality of maintenance scenarios. For example, at the time of the maintenance scenario selection, the user selects a plurality of replacement components or a plurality of setting parameters.

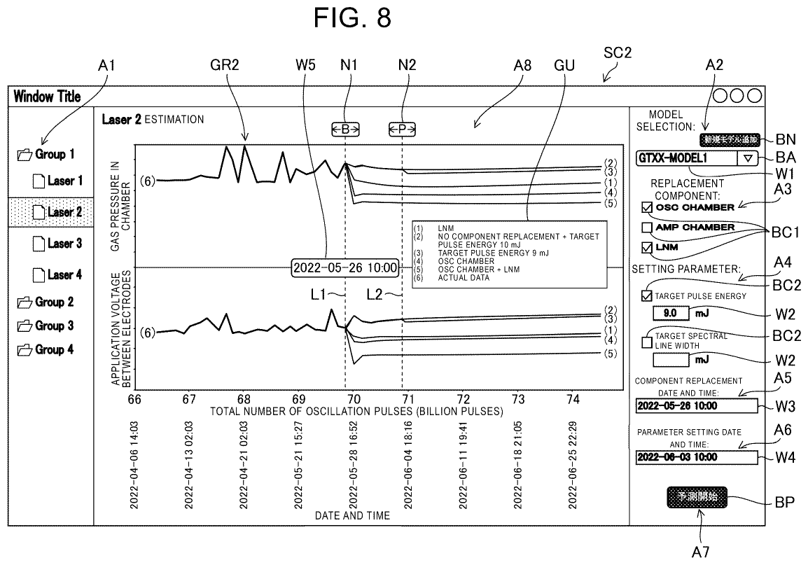

FIG. 8 shows a display screen in the display method according to the second embodiment. The display screen SC2 shown in FIG. 8 is displayed on the monitor 218.

In the example shown in FIG. 8, “Laser2” is selected at the laser device selection section A1, and “GTXX-MODEL1” is selected at the model selection section A2.

Further, in the example shown in FIG. 8, “OSC CHAMBER” and “LNM” are selected at the replacement component selection section A3, and “2022 May 26 10:00” is input at the component replacement date and time input section A5. That is, the replacement component is the chamber 28 and the LNM 26, and the component replacement date and time is 10:00 on May 26, 2022.

Further, in the example shown in FIG. 8, “target pulse energy” is selected and “9.0” is input at the setting parameter selection section A4, and “2022 Jun. 3 10:00” is input at the parameter setting date and time input section A6. That is, the setting parameter is “target pulse energy”, the value of the setting parameter is 9.0 mJ, and the parameter setting date and time is 10:00 on Jun. 3, 2022.

When the user operates the estimation start button BP, the processing device 212 estimates the performance of the laser device “Laser2” using the trained model “GTXX-MODEL1”. At this time, the processing device 212 may perform estimation with respect to a maintenance scenario in which a plurality of maintenance scenarios are combined. For example, in addition to estimation with respect to the component replacement scenario in which the chamber 28 is replaced and estimation with respect to the component replacement scenario in which the LNM 26 is replaced, estimation with respect to the component replacement scenario in which the chamber 28 and the LNM 26 are simultaneously replaced is performed. Further, estimation may be performed with respect to a case in which the component replacement is not performed and the setting parameter is not changed.

When estimation is completed, the processing device 212 displays the estimation result data. The processing device 212 generates a display screen in which estimation result data with respect to each maintenance scenario is superimposed and displayed. Being superimposed and displayed means that the estimation result data with respect to each maintenance scenario is plotted in a region having a common vertical axis and a common horizontal axis, for example. The estimation result data with respect to each maintenance scenario may differ in at least one of a color and a line type of the display in order to be identifiable by the user. Then, the generated display screen is displayed.

Here, the processing device 212 generates a display screen SC2 including a graph GR2 obtained by connecting the temporal transition of the actual data and the temporal transition of the estimation result data, and displays the generated display screen SC2 on the monitor 218. In the example shown in FIG. 8, the graph GR2 is displayed at the estimation result display section A8. The estimation starts at 10:00 on May 26, 2022. The estimated features are the gas pressure in the chamber 28 of the OSC 100 and the application voltage between the electrodes 44, 46.

Further, in the example shown in FIG. 8, a case in which the LNM 26 is replaced, a case in which component replacement is not performed and the target pulse energy Et (=10 mJ) is not changed, a case in which component replacement is not performed and the target pulse energy Et is changed from 10 mJ to 9 mJ, a case in which the chamber 28 is replaced, and a case in which the chamber 28 and the LNM 26 are replaced are superimposed and displayed. Here, the colors of the respective pieces of estimation result data are different from each other, and the correspondence between the estimation result data with respect to the maintenance scenario and the colors are shown in a legend GU displayed at the estimation result display section A8.

The processing device 212 may generate the display screen SC2 in which a line L1 indicating the component replacement date and time is added to the graph GR2. In addition, the processing device 212 may add a knob N1 capable of moving the line L1 along the X-axis direction to the graph GR2. By dragging the knob N1 leftward on the screen, the user can move the position of the line L1 to the date and time on the past side, and by dragging the knob N1 rightward on the screen, the position of the line L1 can be moved to the date and time on the future side. Thus, it is possible to reset the component replacement date and time to the position where the line L1 is moved. Here, the date and time display field W5 indicating the date and time of the position of the line L1 may be displayed during the dragging. After moving the line L1, the user operates the estimation start button BP, so that the processing device 212 may perform estimation based on the reset component replacement date and time.

The processing device 212 may generate the display screen SC2 in which a line L2 indicating the parameter setting date and time is added to the graph GR2. In addition, the processing device 212 may add a knob N2 capable of moving the line L2 along the X-axis direction to the graph GR2. By dragging the knob N2 leftward on the screen, the user can move the position of the line L2 to the date and time on the past side, and by dragging the knob N2 rightward on the screen, the position of the line L2 can be moved to the date and time on the future side. Thus, it is possible to reset the parameter setting date and time to the position where the line L2 is moved. Here, a date and time display field (not shown) indicating the date and time of the position of the line L2 may be displayed during the dragging. After moving the line L2, the user operates the estimation start button BP, so that the processing device 212 may perform estimation based on the reset parameter setting date and time.

To improve the visibility of the display screen SC2, display and non-display of the estimation result data corresponding to a clicked label may be switched by clicking the label of a particular maintenance scenario in the legend GU.

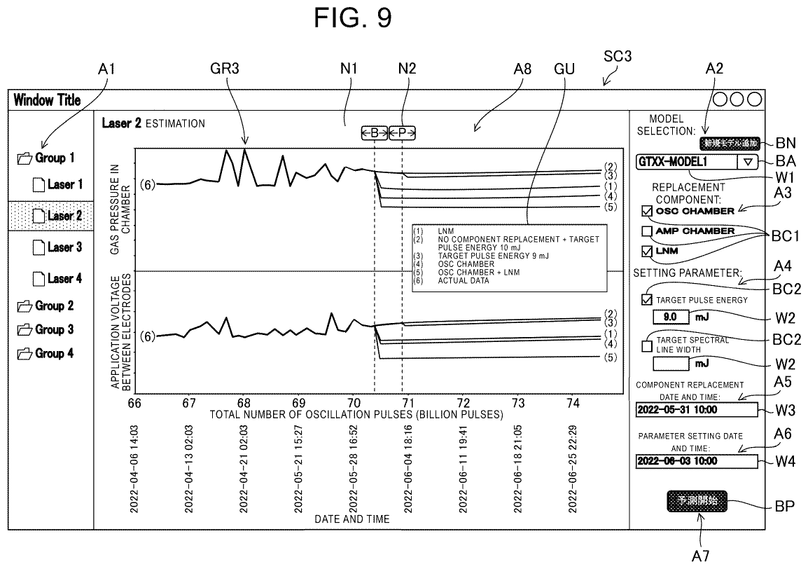

FIG. 9 shows another display screen in the display method according to the second embodiment in a case in which the component replacement date and time and the parameter setting date and time are after the start of estimation. In the example shown in FIG. 9, the start of estimation is 10:00 on May 26, 2022, the component replacement date and time is 10:00 on May 31, 2022, and the parameter setting date and time is 10:00 on Jun. 3, 2022.

On the display screen shown in FIG. 9, a graph GR3 is displayed at the estimation result display section A8. The graph GR3 shows the temporal transition of the estimation result data in a case in which component replacement is not performed from the start of estimation to the component replacement date and time, and the temporal transition of the estimation result data with respect to the component replacement scenario after the component replacement date the graph GR3 and time. Further, shows the temporal transition of the estimation result data in a case in which the parameter setting is not changed, that is, in a case in which the parameter setting is the same as the parameter setting of the actual data, from the start of estimation to the parameter setting date and time, and shows the temporal transition of the estimation result data with respect to the laser setting scenario after the parameter setting date and time.

### 5.3 Effect

According to the second embodiment, effects similar to the first embodiment can be obtained. Further, in the second embodiment, when there are a plurality of maintenance scenarios, the estimation result data with respect to each maintenance scenario is superimposed and displayed, so that it is possible to reduce the difficulty of understanding the effects of the plurality of maintenance scenarios.

### 6. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A display method for displaying estimation result data of a feature of a laser device after an estimation start timing, the estimation result data being obtained using a trained model and actual data of the laser device up to the estimation start timing,
the display method comprising:
storing the actual data and the estimation result data;
generating a display screen in which temporal transition of the actual data and temporal transition of the estimation result data are connected and displayed; and
displaying the display screen.

2. The display method according to claim 1,
wherein the estimation result data includes an estimation result with respect to a component replacement scenario including data of a replacement component and a component replacement timing at which the replacement component is to be replaced.

3. The display method according to claim 2,
comprising generating a display screen in which a line indicating the component replacement timing is added.

4. The display method according to claim 2,
wherein the estimation result data includes an estimation result with respect to a plurality of the component replacement scenarios,
the display method comprising generating a display screen in which a plurality of pieces of the estimation result data corresponding to the plurality of the component replacement scenarios are superimposed and displayed.

5. The display method according to claim 4, comprising:
generating a display screen including a graph in which at least one of a color and a line type of the estimation result data of each of the plurality of pieces of the estimation result data is different.

6. The display method according to claim 2,
wherein the estimation result data further includes the estimation result in a case in which the replacement component is not replaced.

7. The display method according to claim 1,
wherein the estimation result data includes an estimation result with respect to a laser setting scenario including data of a value of a setting parameter to be changed of laser setting of the laser device and a parameter setting timing at which the value of the setting parameter is to be changed.

8. The display method according to claim 7,
comprising generating a display screen in which a line indicating the parameter setting timing is added.

9. The display method according to claim 7,
wherein the estimation result data: includes the estimation result with respect to a plurality of the laser setting scenarios,
the display method comprising generating a display screen in which a plurality of pieces of the estimation result data corresponding to the plurality of the laser setting scenarios are superimposed and displayed.

10. The display method according to claim 9,
comprising generating a display screen including a graph in which at least one of a color and a line type of the estimation result data of each of the plurality of pieces of the estimation result data is different.

11. The display method according to claim 7,
wherein the estimation result data further includes the estimation result in a case in which the laser setting is not changed.

12. The display method according to claim 1,
wherein the display screen includes a graph obtained by connecting and displaying temporal transition of the actual data and temporal transition of the estimation result data, and
date and time and a total number of oscillation pulses are shown together on a horizontal axis of the graph

13. The display method according to claim 1,
wherein the estimation result data includes estimation result data of a plurality of the features, and
the display screen includes a graph in which displaying is separated into upper and lower stages for the respective features with a common horizontal axis.

14. The display method according to claim 1,
wherein the display screen includes a model selection section for selecting the trained model.

15. The display method according to claim 14,
wherein the model selection section includes a candidate of the trained model associated with the laser device.

16. The display method according to claim 2,
wherein the display screen includes a replacement component selection section for selecting the replacement component.

17. The display method according to claim 16,
wherein the replacement component selection section includes a candidate of the replacement component associated with the trained model.

18. The display method according to claim 7,
wherein the display screen includes a setting parameter selection n section for selecting the setting parameter to be changed of the laser setting of the laser device.

19. The display method according to claim 18,
wherein the setting parameter selection section includes a candidate of the setting parameter of the laser setting associated with the trained model.

20. A display apparatus for displaying estimation result data of a feature of a laser device after an estimation start timing, the estimation result data being obtained using a trained model and actual data of the laser device up to the estimation start timing,
the display apparatus comprising:
a storage device configured to store the actual data and the estimation result data;
a processing device configured to generate a display screen in which temporal transition of the actual data and temporal transition of the estimation result data are connected and displayed; and
a monitor configured to display the display screen.
